(19) United States
(12) Patent Application Publication
(10) Pub. No.: US 2021/0102483 A1
(43) Pub. Date: Apr. 8, 2021

(54) SEALING STRUCTURE

(71) Applicants: Mahle International GmbH, Stuttgart (DE); Mahle Filter Systems Japan Corporation, Tokyo (JP)

(72) Inventors: Shintaro Ishigami, Tokyo (JP); Daizo Ito, Tokyo (JP); Satoshi Komiyama, Tokyo (JP); Atsushi Nonaka, Tokyo (JP)

(21) Appl. No.: 17/064,586

(22) Filed: Oct. 6, 2020

(30) Foreign Application Priority Data
Oct. 7, 2019 (JP) 2019184414

(51) Int. Cl. F01M 11/04; F01M 11/00

(52) U.S. Cl. CPC F01M 11/0408; F01M 2011/0416; F01M 11/0004

(57) ABSTRACT

[Problem to be Solved] To improve operability in detaching a sealing member.

[Solution] A sealing structure 10 according to the present invention includes a main body 30a, a female thread part 20h fixed to the main body 30a, the female thread part 20h being screwed into a discharge hole 20c of a drain plug fastening part 20 by the main body 30a being rotated in a normal rotation direction, and an elastically deformable arm part 30c, one end of which is joined to the main body 30a. A concave part 20e is formed in the drain plug fastening part 20 and a claw part 30g is formed in the arm part 30c. When the main body 30a is rotated in the normal rotation direction, the arm part 30c is elastically deformed while a part of the arm part 30c slides on a top surface 20d of the drain plug fastening part 20 until the main body 30a is rotated to a predetermined rotational position and, when the main body 30a is rotated to the predetermined rotational position, the claw part 30g fits in the concave part 20e and the elastic deformation of the arm part 30c is released, whereby the rotation of the main body 30a from the predetermined rotational position is prevented. When the main body 30a is rotated in a reverse rotation direction from the predetermined rotational position, the claw part 30g slides on and climbs over a first wall part 20f of the concave part 20e while the arm part 30c is elastically deformed, whereby the prevention of the rotation of the main body 30a from the predetermined rotational position is released. The claw part 30g or the concave part 20e is formed such that, when the main body 30a is rotated in the reverse rotation direction and the claw part 30g is sliding on the first wall part 20f, an angle A formed by a direction of force applied to the arm part 30c from the drain plug fastening part 20 and a straight line connecting a contact part of the claw part 30g and the first wall part 20f and a rotation center of the main body 30a is smaller than 90 degrees when viewed in a rotation center direction of the main body 30a.

### CROSS-REFERENCE TO RELATED APPLICATION

This application claims priority to Japanese Application No. JP 2019184414 filed on Oct. 7, 2019, the contents of which are hereby incorporated by reference in its entirety.

### TECHNICAL FIELD

The present invention relates to a sealing structure and, more particularly, to a sealing structure of an oil pan by a drain plug.

### BACKGROUND

There has been known a sealing structure for sealing an opening part of a predetermined member with a sealing member, such as a drain plug, the sealing structure being detached from the predetermined member by being rotated in a reverse rotation direction, for example, using a predetermined tool. As an example of such a sealing structure, there has been proposed a drain plug structure of an oil pan including locking meshing parts that are formed at both of distal end portions of arcuate arm parts and an opening edge part of the drain hole and fit with each other in a recess-protrusion manner to exert a locking function (see, for example, Patent Literature 1).

[Patent Literature 1] Japanese Patent Application Laid-Open No. 2019-100222

### SUMMARY

The sealing structure described in Patent Literature 1 includes the arcuate arm parts. When the sealing member is rotated in the reverse rotation direction and detached from the predetermined member such as the oil pan, force is applied to the arcuate arm parts 15 in a direction parallel to the tangent of an arc. That is, an angle formed by a straight line connecting a part, where the force is applied to the arcuate arm parts 15, and a rotation center, and a direction of the force applied to the arcuate arm parts 15 is a right angle. As a result of the researches and developments by the inventor, it has been found that, when such force in the direction is applied to the arcuate arm parts 15, force is applied to the arcuate arm parts 15 in a radial outward direction and, when the sealing member is rotated in the reverse rotation direction, not only step surface climbing reaction at the time when engaging convex parts (locking meshing parts) 16 at the distal ends of the arcuate arm parts 15 climb over a step of an engaging concave part (a locking meshing part) 17 but also reaction due to a bend outward in a rotating direction of the arcuate arm parts 15 is large and discomfort occurs in operation. Accordingly, there has been room of improvement in operability in detaching the sealing member.

Therefore, the present invention has been devised in view of the above problem and an object of the present invention is to improve operability in detaching the sealing member from the predetermined member.

In order to solve the problem, a sealing structure according to the present invention includes: a predetermined member including an opening part; and a sealing member that seals the opening part of the predetermined member. The sealing member includes: a main body, a thread part fixed to the main body, wherein if the main body is rotated in a normal rotation direction, the thread part is screwed into the opening part of the predetermined member; and an elastically deformable arm part joined to the main body at one end thereof. A convex part is formed in one of the predetermined member and the arm part and a concave part is formed in another of the predetermined member and the arm part. If the main body is rotated in the normal rotation direction, the arm part is elastically deformed while a part of the arm part slides on a surface of the predetermined member until the main body is rotated to a predetermined rotational position and, when the main body is rotated to the predetermined rotational position, the convex part fits in the concave part and the elastic deformation of the arm part is released, whereby the rotation of the main body from the predetermined rotational position is prevented. If the main body is rotated in a reverse rotation direction from the predetermined rotational position, the convex part slides on and climbs over a wall part of the concave part while the arm part is elastically deformed, whereby the prevention of the rotation of the main body from the predetermined rotational position is released. The convex part or the concave part is formed such that, when the main body is rotated in the reverse rotation direction and the convex part is sliding on the wall part, an angle A formed by a direction of force applied to the arm part from the predetermined member and a straight line connecting a contact part of the convex part and the wall part and a rotation center of the main body is smaller than 90 degrees when viewed in a rotation center direction of the main body.

With this form, when the sealing member is rotated in the reverse rotation direction, for example, using a predetermined tool, it is possible to suppress the arm part from being rotated around the contact part by force applied to the arm part from the predetermined member. Accordingly, it is possible to improve operability in detaching the sealing member from the predetermined member.

When an angle formed by a straight line connecting the contact part of the convex part and the wall part and a joined part of the arm part and the main body and the straight line connecting the contact part of the convex part and the wall part and the rotation center of the main body is represented as an angle B, the convex part or the concave part may be formed such that 90 degrees>the angle A≥the angle B holds.

With this form, it is possible to further suppress the arm part from being rotated around the contact part by the force applied to the arm part from the predetermined member. Accordingly, it is possible to further improve operability in detaching the sealing member from the predetermined member.

The convex part or the concave part may be formed such that the angle A and the angle B are equal. With this form, it is possible to avoid the arm part being rotated around the contact part by the force applied to the arm part from the predetermined member. Accordingly, it is possible to greatly improve the operability in detaching the sealing member from the predetermined member.

Note that the concave part may be formed in the predetermined member and the convex part may be formed in the arm part. The convex part may be formed in the predetermined member and the concave part may be formed in the arm part.

The predetermined member may be made of resin. Since the convex part is fit in the concave part, reverse rotation of the sealing member can be prevented even if the sealing member is not screwed into the predetermined member with strong torque. Accordingly, it is possible to improve reliability of the thread part even when the predetermined member is resin.

The predetermined member may be an oil pan and the sealing member may be a drain plug. With this form, it is possible to improve operability in detaching the drain plug from the oil pan.

According to the present invention, it is possible to improve operability in detaching the sealing member.

### BRIEF DESCRIPTION OF THE DRAWINGS

FIG. 1 is a perspective view showing a sealing structure according to a first embodiment.

FIG. 2 is a perspective view showing a drain plug according to the first embodiment.

FIG. 3 is a front view of the drain plug according to the first embodiment.

FIG. 4 is a rear view of the drain plug according to the first embodiment.

FIG. 5 is a perspective view showing a drain plug fastening part according to the first embodiment.

FIG. 6 is a front view of the drain plug fastening part according to the first embodiment.

FIG. 7 is a sectional view of a sealing structure by a plane including a rotation center.

FIG. 8 is a front view of the sealing structure at the time when the drain plug is screwed into the drain plug fastening part.

FIG. 9 is a P-P sectional view of FIG. 8.

FIG. 10 is a perspective view showing a sealing structure according to a second embodiment.

FIG. 11 is a front view of a drain plug according to the second embodiment.

FIG. 12 is a rear view of the drain plug according to the second embodiment.

FIG. 13 is a perspective view showing a drain plug fastening part according to the second embodiment.

FIG. 14 is a front view of the drain plug fastening part according to the second embodiment.

FIG. 15 is a front view of the sealing structure at the time when the drain plug is screwed into the drain plug fastening part.

FIG. 16 is a Q-Q sectional view of FIG. 15.

### DETAILED DESCRIPTION

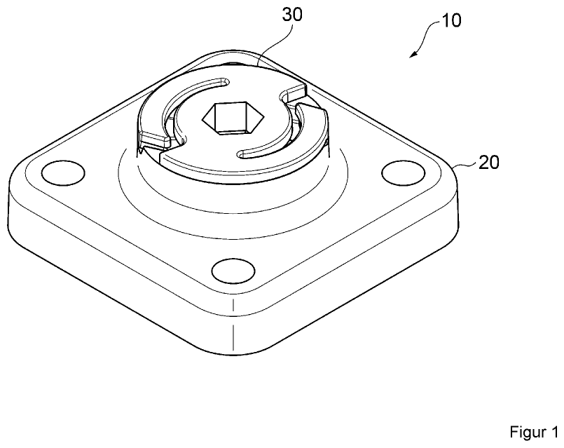

FIG. 1 is a perspective view showing a sealing structure 10 according to a first embodiment. The sealing structure 10 includes a drain plug fastening part 20 (a predetermined member) and a drain plug 30 (a sealing member).

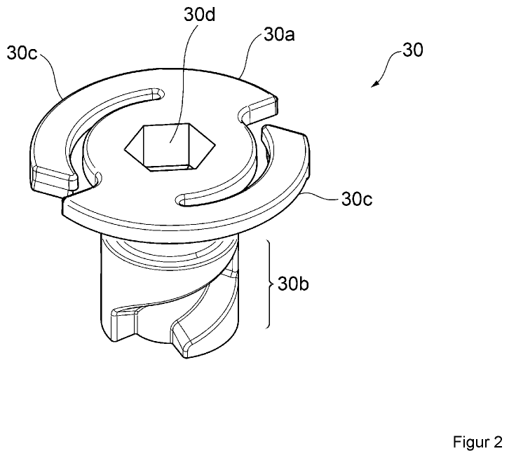

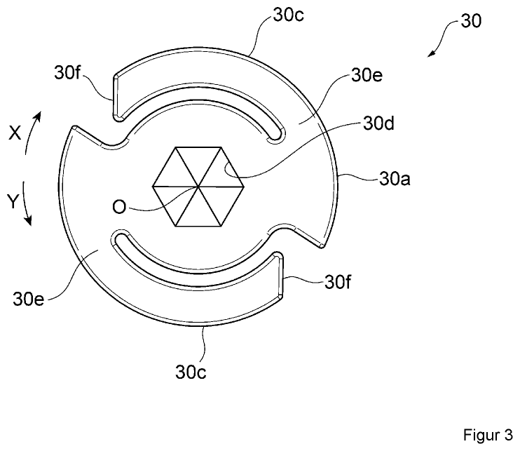

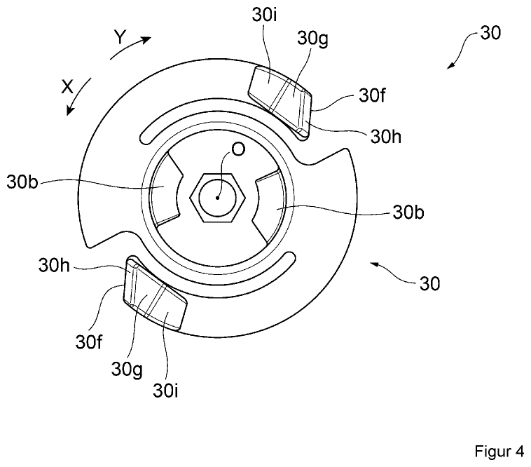

FIG. 2 is a perspective view showing the drain plug 30 according to the first embodiment. FIG. 3 is a front view of the drain plug 30 according to the first embodiment. FIG. 4 is a rear view of the drain plug 30 according to the first embodiment. The drain plug 30 includes a main body 30a, a male thread part 30b, and an arm part 30c.

The main body 30a is generally formed in a columnar shape. The main body 30a is rotated in a normal rotation direction X to thereby be screwed into a discharge hole explained below of the drain plug fastening part 20. Consequently, the discharge hole of the drain plug fastening part 20 is closed.

The arm part 30c is formed in an arcuate shape coaxial with a rotation center O of the main body 30a. One end of the arm part 30c is joined to the main body 30a. The main body 30a, the male thread part 30b, and the arm part 30c are integrally formed by resin. Accordingly, the arm part 30c is elastically deformable. In the first embodiment, the drain plug 30 includes two arm parts 30c. However, the drain plug 30 may include one or three or more arm parts 30c.

A claw part 30g (a convex part) is formed at the other end 30f of the arm part 30c. The other end 30f of the arm part 30c is present further in a reverse rotation direction Y than one end joined to the main body 30a. The claw part 30g is formed on the lower side of the arm part 30c, that is, the male thread part 30b side.

The claw part 30g includes a first inclined part 30h and a second inclined part 30i. The first inclined part 30h is present further in the reverse rotation direction Y than the second inclined part 30i. The first inclined part 30h and the second inclined part 30i are inclined to be closer to each other as progress toward a projecting direction of the claw part 30g. The second inclined part 30i extends on a straight line that passes the rotation center O. The first inclined part 30h is inclined with respect to the straight line passing the rotation center O to advance in a normal rotation direction X as advance toward a radial direction outer side.

The male thread part 30b is formed to extend coaxially with the main body 30a from one end portion of the main body 30a. The male thread part 30b is formed as a spiral groove. A pitch and a groove width of the male thread part 30b are extremely larger than those of a normal screw such that the drain plug 30 can be attached to the drain plug fastening part 20 by rotating the drain plug 30 once or less.

The drain plug 30 further includes a tool insertion hole 30d. The tool insertion hole 30d is disposed as a concave part at the other end portion of the main body 30a. In the first embodiment, the tool insertion hole 30d is formed as a hexagonal concave part when viewed from the front such that a hexagonal wrench is fit into the tool insertion hole 30d. However, for example, a projecting part having a hexagonal prism shape may be formed instead of the tool insertion hole 30d.

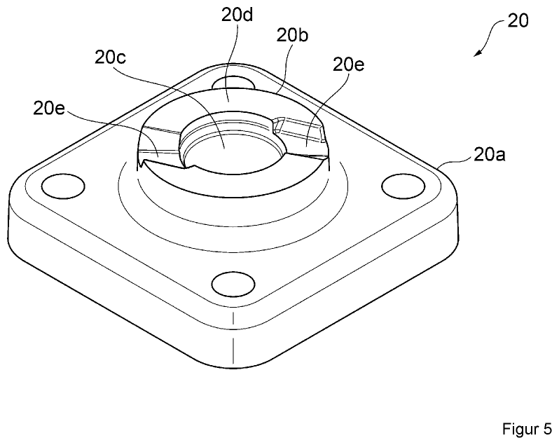

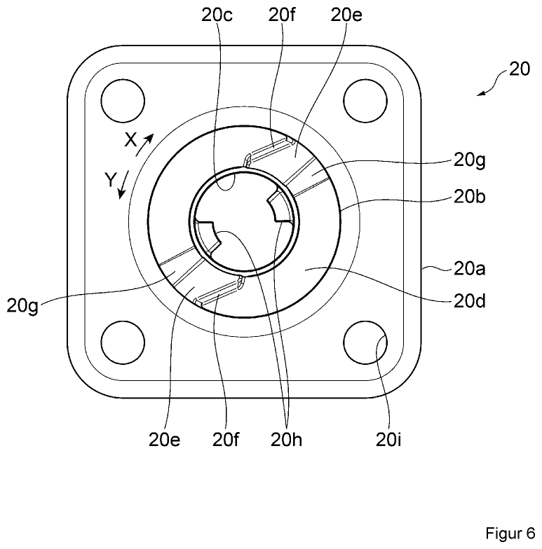

FIG. 5 is a perspective view showing the drain plug fastening part 20 according to the first embodiment. FIG. 6 is a front view of the drain plug fastening part 20 according to the first embodiment. The drain plug fastening part 20 includes a base part 20a, a projecting part 20b, and a discharge hole 20c. The base part 20a is formed in a rectangular parallelepiped shape. Four attachment holes 20i are formed in the base part 20a. The drain plug fastening part 20 is fixed to an oil pan main body through the attachment holes 20i using a fastening tool. Therefore, the drain plug fastening part 20 forms a part of the oil pan.

The projecting part 20b projects from one surface of the base part 20a. The projecting part 20b is formed in a columnar shape. A top surface 20d, which is an annular plane, is formed at the distal end of the projecting part 20b. A concave part 20e is formed to recess from the top surface 20d.

The concave part 20e includes a first wall part 20f and a second wall part 20g. The first wall part 20f is present further in the reverse rotation direction Y than the second wall part 20g. When the drain plug 30 is rotated in the reverse rotation direction Y, the first wall part 20f comes into contact with the first inclined part 30h of the drain plug 30. When the drain plug 30 is rotated in the normal rotation direction X, the second wall part 20g comes into contact with the second inclined part 30i of the drain plug 30. Accordingly, an inclination angle of the first wall part 20f is the same as an inclination angle of the first inclined part 30h. An inclination angle of the second wall part 20g is the same as an inclination angle of the second inclined part 30i.

The second wall part 20g extends on a straight line that passes the rotation center O. The first wall part 20f is inclined with respect to the straight line passing the rotation center O to advance in the normal rotation direction X as advance toward the radial direction outer side.

The discharge hole 20c is formed in the center of the projecting part 20b. A female thread part 20h is formed in the discharge hole 20c. The female thread part 20h is formed as a projecting part projecting in a radial inward direction from the discharge hole 20c.

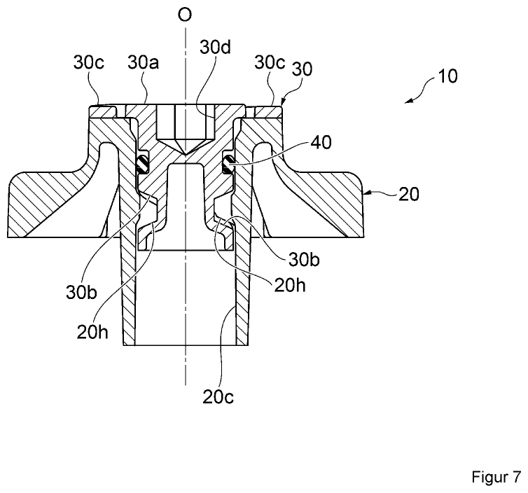

FIG. 7 is a sectional view of the sealing structure 10 by a plane including the rotation center O. The sealing structure 10 further includes a seal member 40. The seal member 40 seals a space between the drain plug 30 and the discharge hole 20c of the drain plug fastening part 20. In the first embodiment, play in a circumferential direction is present between the claw part 30g and the concave part 20e. Accordingly, even in a state in which the claw part 30g of the drain plug 30 is fit in the concave part 20e of the drain plug fastening part 20, the drain plug 30 is capable of slightly rotating with respect to the drain plug fastening part 20. However, even when the drain plug 30 is capable of slightly rotating with respect to the drain plug fastening part 20, it is possible to surely seal the discharge hole 20c with the seal member 40 in this way.

The drain plug fastening part 20 and the drain plug 30 are made of resin. However, since the claw part 30g is fit in the concave part 20e, even if the drain plug 30 is not screwed into the drain plug fastening part 20 with strong torque, reverse rotation of the drain plug 30 can be prevented. Accordingly, when the drain plug fastening part 20 and the drain plug 30 are resin, it is possible to avoid deterioration in reliability of the female thread part 20h and the male thread part 30b.

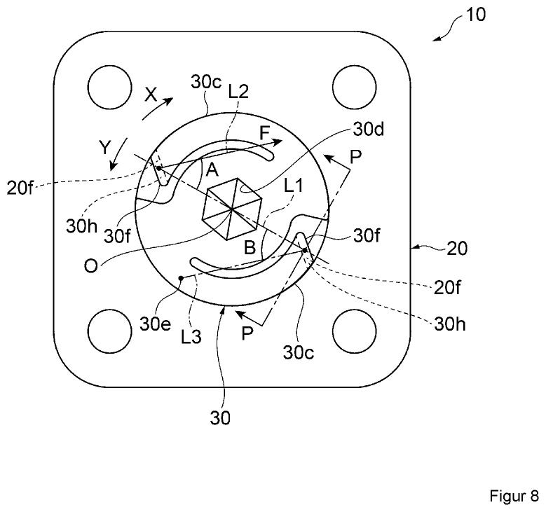

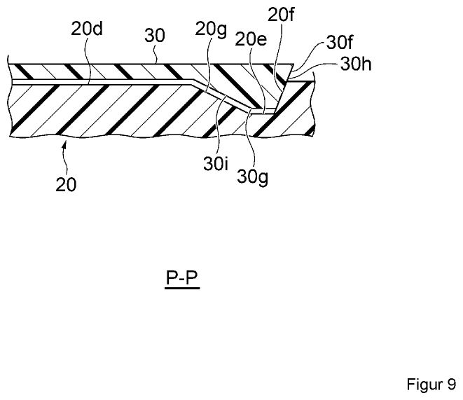

FIG. 8 is a front view of the sealing structure 10 at the time when the drain plug 30 is screwed into the drain plug fastening part 20. FIG. 9 is a P-P sectional view of FIG. 8. One end of the main body 30a of the drain plug 30 is inserted into the discharge hole 20c of the drain plug fastening part 20 and the drain plug 30 is rotated in the normal rotation direction X by a tool, whereby the drain plug 30 is screwed into the drain plug fastening part 20 while the male thread part 30b of the drain plug 30 meshing with the female thread part 20h of the drain plug fastening part 20.

When the main body 30a is rotated in the normal rotation direction X using the tool, the arm part 30c is elastically deformed while the claw part 30g sliding on the top surface 20d (the surface) of the drain plug fastening part 20 until the main body 30a is rotated to a predetermined rotational position. The claw part 30g fits in the concave part 20e when the main body 30a is rotated to the predetermined rotational position. The elastic deformation of the arm part 30c is released. In this way, the main body 30a is prevented from rotating from the predetermined rotational position without the use of the tool. The drain plug 30 is avoided being coming off the drain plug fastening part 20 without the use of the tool.

When the main body 30a is rotated in the reverse rotation direction Y using the tool when the claw part 30g is fit in the concave part 20e, the claw part 30g slides on and climbs over the first wall part 20f (the wall part) of the concave part 20e of the claw part 30g while the arm part 30c is elastically deformed. In this way, the prevention of the rotation of the main body 30a from the predetermined rotational position is released.

A straight line connecting a contact part of the claw part 30g and the first wall part 20f and the rotation center O of the main body 30a when viewed in the rotation center O direction of the main body 30a when the main body 30a is rotated in the reverse rotation direction Y and the claw part 30g is sliding on the first wall part 20f is represented as a straight line L1. A straight line indicating a direction of force F applied to the claw part 30g from the first wall part 20f, that is, the force F applied to the arm part 30c from the drain plug fastening part 20 is represented as a straight line L2. A straight line connecting the contact part of the claw part 30g and the first wall part 20f and a joined part 30e of the arm part 30c and the main body 30a is represented as a straight line L3. Further, an angle formed by the straight line L1 and the straight line L2 is represented as an angle A. An angle formed by the straight line L1 and the straight line L3 is represented as an angle B.

In the first embodiment, the claw part 30g and the concave part 20e are formed such that the angle A and the angle B are equal. Specifically, the first inclined part 30h is formed such that the straight line connecting the joined part 30e and the center of the first inclined part 30h and the extending direction of the first inclined part 30h form a right angle when viewed in the direction of the rotation center O. The first wall part 20f is formed to extend in the same direction as the first inclined part 30h when the first wall part 20f comes into contact with the first inclined part 30h. Consequently, the arm part 30c is avoided being rotated around the contact part in a radial outward direction by force applied to the claw part 30g from the first wall part 20f. Accordingly, it is possible to greatly improve operability in detaching the drain plug 30 from the drain plug fastening part 20.

Note that, not only the above, but the claw part 30g or the concave part 20e may be formed such that the angle A is smaller than 90 degrees. The claw part 30g or the concave part 20e may be formed such that 90 degrees>the angle A≥the angle B holds. Consequently, when the drain plug 30 is rotated in the reverse rotation direction using a predetermined tool, it is possible to suppress the arm part 30c from being rotated around the contact part by force applied to the claw part 30g from the first wall part 20f Accordingly, it is possible to improve operability in detaching the drain plug 30 from the drain plug fastening part 20. The sealing structure 10 may be used for uses other than the fastening of the drain plug to the oil pan.

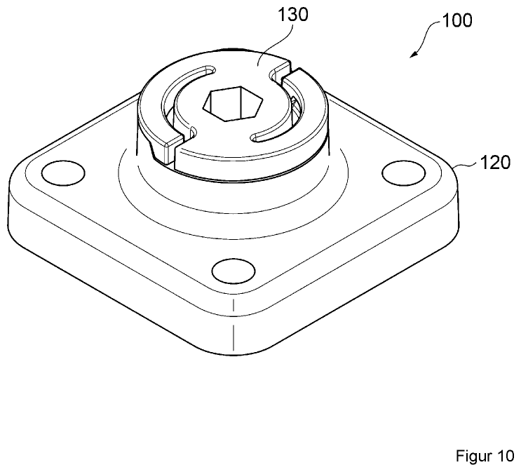

FIG. 10 is a perspective view showing a sealing structure 100 according to a second embodiment. The sealing structure 100 includes a drain plug fastening part 120 (a predetermined member) and a drain plug 130 (a sealing member).

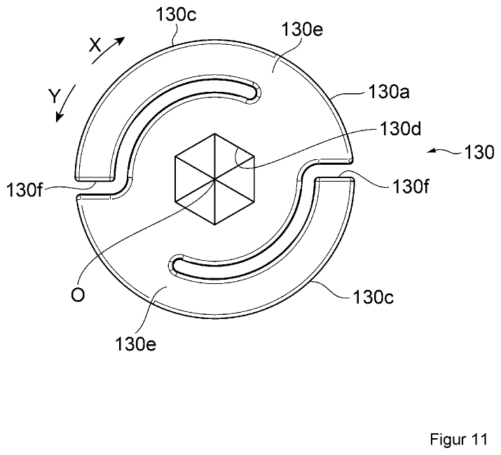

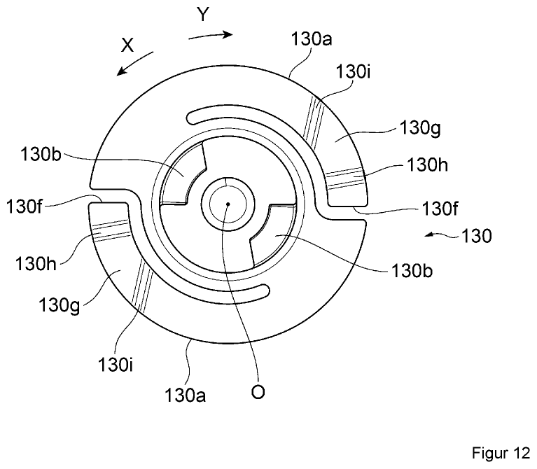

FIG. 11 is a front view of the drain plug 130 according to the second embodiment. FIG. 12 is a rear view of the drain plug 130 according to the second embodiment. The drain plug 130 includes a main body 130a, a male thread part 130b, an arm part 130c.

The main body 130a is generally formed in a columnar shape. The main body 130a is rotated in the normal rotation direction X, whereby the drain plug fastening part 120 is screwed into a discharge hole explained below. Consequently a discharge hole of the drain plug fastening part 120 is closed.

The arm part 130c is formed in an arcuate shape coaxial with the center of the main body 130a. One end of the arm part 130c is joined to the main body 130a. The main body 130a, the male thread part 130b, and the arm part 130c are integrally formed by resin. Accordingly, the arm part 130c is elastically deformable. In the second embodiment, the drain plug 130 includes two arm parts 130c. However, the drain plug 130 may include one or three or more arm parts 130c.

A concave part 130g is formed in a halfway part of the arm part 130c. The concave part 130g is present further in the reverse rotation direction Y than one end of the arm part 130c joined to the main body 130a. The concave part 130g is formed on the lower side of the arm part 130c, that is, the male thread part 130b side.

The concave part 130g includes a first wall part 130h and a second wall part 130i. The first wall part 130h is present further in the reverse rotation direction Y than a second wall part 103i. The first wall part 130h extends on a straight line that passes the rotation center O. The second wall part 130i is inclined with respect to the straight line passing the rotation center O to advance in the normal rotation direction X as advance toward the radial direction outer side.

The male thread part 130b is formed to extend coaxially with the main body 130a from one end portion of the main body 130a. The male thread part 130b is formed as a spiral groove. A pitch and a groove width of the male thread part 130b are extremely larger than those of a normal screw such that the drain plug 130 can be attached to the drain plug fastening part 20 by rotating the drain plug 130 once or less.

The drain plug 130 further includes a tool insertion hole 130d. The tool insertion hole 130d is the same as the tool insertion hole 30d in the first embodiment.

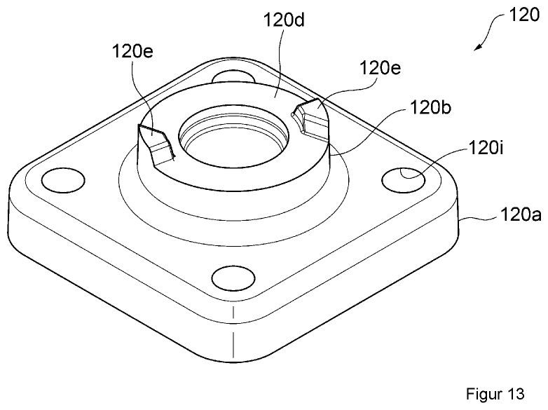

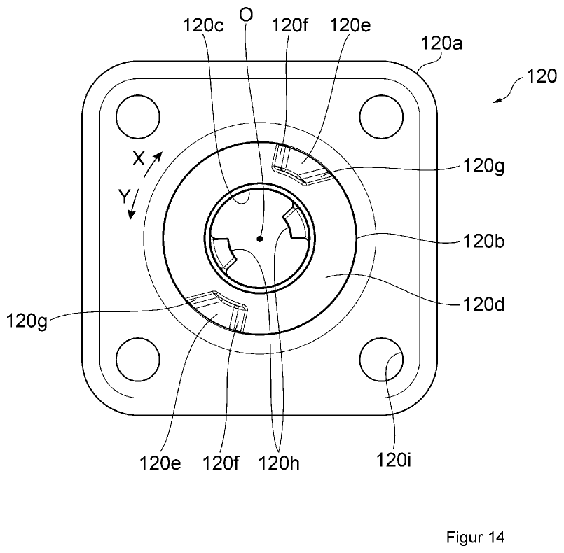

FIG. 13 is a perspective view showing the drain plug fastening part 120 according to the second embodiment. FIG. 14 is a front view of the drain plug fastening part 120 according to the second embodiment. The drain plug fastening part 120 includes a base part 120a, a projecting part 120b, and a discharge hole 120c. The base part 120a is formed in a rectangular parallelepiped shape. Four attachment holes 120i are formed in the base part 120a. The drain plug fastening part 120 is fixed to an oil pan main body through the attachment holes 120i using a fastening tool. Therefore, the drain plug fastening part 120 forms a part of the oil pan.

The projecting part 120b projects from one surface of the base part 120a. The projecting part 120b is formed in a columnar shape. A top surface 120d, which is an annular plane, is formed at the distal end of the projecting part 120b. A convex part 120e is formed to project from the top surface 120d.

The convex part 120e includes a first inclined part 120f and a second inclined part 120g. The first inclined part 120f is present further in the reverse rotation direction Y than the second inclined part 120g. The first inclined part 120f and the second inclined part 120g are inclined to be closer to each other as progress toward a projecting direction of the convex part 120e. When the drain plug 130 is rotated in the positive rotation direction X, the first inclined part 120f comes into contact with the first wall part 130h of the drain plug 130. When the drain plug 130 is rotated in the reverse rotation direction Y, the second inclined part 120g comes into contact with the second wall part 130i of the drain plug 130. Accordingly, an inclination angle of the first wall part 130h is the same as an inclination angle of the first inclined part 120f An inclination angle of the second wall part 130i is the same as an inclination angle of the second inclined part 12g.

The first inclined part 120f extends on a straight line that passes the rotation center O. The second inclined part 120g is inclined with respect to the straight line passing the rotation center O to advance in the positive rotation direction X as advance toward the radial outer side.

The discharge hole 120c is formed in the center of the projecting part 120b. A female thread part 120h is formed in the discharge hole 120c. The discharge hole 120c and the female thread part 120h are the same as the discharge hole 20c and the female thread part 20h according to the first embodiment.

In the second embodiment as well, the sealing structure 100 further includes a seal member (not illustrated). The seal member seals a space between the drain plug 130 and the discharge hole 120c of the drain plug fastening part 120. In the second embodiment, play in a circumferential direction is present between the concave part 130g and the convex part 120e. Accordingly, even in a state in which the convex part 120e of the drain plug 30 is fit in the concave part 130g, the drain plug 130 is capable of slightly rotating with respect to the drain plug fastening part 120. However, even when the drain plug 130 is capable of slightly rotating with respect to the drain plug fastening part 120, the discharge hole 120c can be surely sealed by the seal member in this way.

The drain plug fastening part 120 and the drain plug 130 are made of resin. However, since the convex part 120e is fit in the concave part 130g, even if the drain plug 130 is not screwed into the drain plug fastening part 120 with strong torque, reverse rotation of the drain plug 130 can be prevented as in the first embodiment.

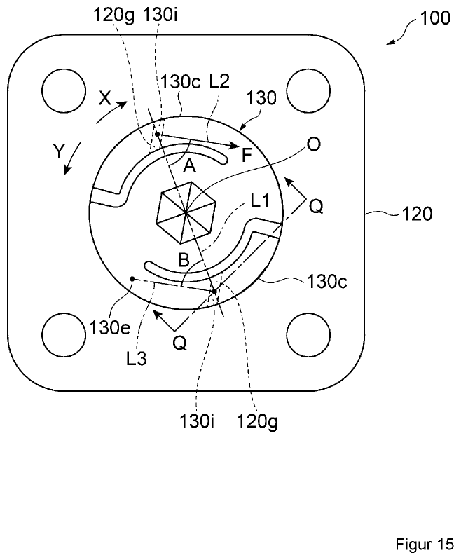

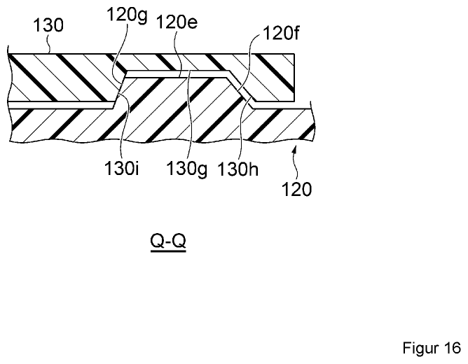

FIG. 15 is a front view of the sealing structure 100 at the time when the drain plug 130 is screwed into the drain plug fastening part 120. FIG. 16 is a Q-Q sectional view of FIG. 14. One end of the main body 130a of the drain plug 130 is inserted into the discharge hole 120c of the drain plug fastening part 120 and the drain plug 130 is rotated in the normal rotation direction X by a tool, whereby the drain plug 130 is screwed into the drain plug fastening part 120 while the male thread part 130b of the drain plug 130 meshing with the female thread part 120h of the drain plug fastening part 120.

When the main body 130a is rotated in the normal rotation direction X, the arm part 130c is elastically deformed while a part of the arm part 130c slides on the top surface 120d (the surface) of the drain plug fastening part 120 until the main body 130a is rotated to a predetermined rotational position. When the main body 130a is rotated to the predetermined rotational position, the convex part 120e fits in the concave part 130g and the elastic deformation of the arm part 130c is released. In this way, the main body 130a is prevented from rotating from the predetermined rotational position without the use of the tool. The drain plug 130 is avoided coming off the drain plug fastening part 120 without the use of the tool.

When the main body 130a is rotated in the reverse rotation direction Y using the tool, the convex part 120e slides on and climbs over the second wall part 130i (a wall part) of the concave part 130g while the arm part 130c is elastically deformed. In this way, the prevention of the rotation of the main body 130a from the predetermined rotational position is released.

A straight line connecting a contact part of the second inclined part 120g and the second wall part 130i and the rotation center O of the main body 130a when viewed in the rotation center O direction of the main body 130a when the main body 130a is rotated in the reverse rotation direction Y and the second inclined part 120g is sliding on the second wall part 130i is represented as the straight line L1. A straight line indicating a direction of the force F applied to the second wall part 130i from the second inclined part 120g, that is, the force F applied to the arm part 130c from the drain plug fastening part 120 is represented as the straight line L2. A straight line connecting the contact part of the second inclined part 120g and the second wall part 130i and a joined part 130e of the arm part 130c and the main body 130a is represented as the straight line L3. Further, an angle formed by the straight line L1 and the straight line L2 is represented as the angle A. An angle formed by the straight line L1 and the straight line L3 is represented as the angle B.

In the second embodiment as well, the convex part 120e and the concave part 130g are formed such that the angle A and the angle B are equal. Specifically, the second wall part 130i is formed such that the straight line connecting the joined part 130e and the center of the second wall part 130i and the extending direction of the second wall part 130i form a right angle when viewed in the direction of the rotation center O. The second inclined part 120g is formed to extend in the same direction as the second wall part 130i when the second inclined part 120g comes into contact with the second wall part 130i. Consequently, the arm part 130c is avoided being rotated around the contact part in a radial outward direction by the force F applied to the second wall part 130i from the second inclined part 120g. Accordingly, it is possible to greatly improve operability in detaching the drain plug 130 from the drain plug fastening part 120.

Note that, not only the above, but the concave part 130g and the convex part 120e may be formed such that the angle A is smaller than 90 degrees. The concave part 130g and the convex part 120e may be formed such that 90 degrees>the angle A≥the angle B holds. Consequently, when the drain plug 130 is rotated in the reverse rotation direction using a predetermined tool, it is possible to suppress the arm part 130c from being rotated around the contact part by the force F applied to the second wall part 130i from the second inclined part 120g. Accordingly, it is possible to improve operability in detaching the drain plug 130 from the drain plug fastening part 120. The sealing structure 100 may be used for uses other than the fastening of the drain plug to the oil pan.

The present invention is explained above with reference to the embodiment. However, the present invention is not limited to the embodiment explained above. Appropriate combinations and substitutions of the components in the embodiment are also included in the present invention. It is also possible to appropriately rearrange the combinations and the order of the processing in the embodiment and add various modifications such as design changes to the embodiment based on the knowledge of those skilled in the art. The embodiment applied with such modifications could be included in the scope of the present invention.

1. A sealing structure comprising:
a predetermined member including an opening part; and
a sealing member for sealing the opening part of the predetermined member, wherein the sealing member includes:
a main body;
a thread part fixed to the main body, wherein if the main body is rotated in a normal rotation direction, the thread part is screwed into the opening part of the predetermined member; and
an elastically deformable arm part joined to the main body at one end thereof,
wherein a convex part is formed in one of the predetermined member and the arm part and a concave part is formed in another of the predetermined member and the arm part,
if the main body is rotated in the normal rotation direction, the arm part is elastically deformed while a part of the arm part slides on a surface of the predetermined member until the main body is rotated to a predetermined rotational position and, when the main body is rotated to the predetermined rotational position, the convex part fits in the concave part and the elastic deformation of the arm part is released, whereby the rotation of the main body from the predetermined rotational position is prevented,
if the main body is rotated to a reverse rotation direction from the predetermined rotational position, the convex part slides on and climbs over a wall part of the concave part while the arm part is elastically deformed, whereby the prevention of the rotation of the main body from the predetermined rotational position is released, and
wherein the convex part or the concave part is formed such that, when the main body is being rotated in the reverse rotation direction and the convex part is sliding on the wall part, an angle A formed by a direction of force applied to the arm part from the predetermined member and a straight line connecting a contact part of the convex part and the wall part and a rotation center of the main body is smaller than 90 degrees when viewed in a rotation center direction of the main body.

2. The sealing structure according to claim 1, wherein, when an angle formed by a straight line connecting the contact part of the convex part and the wall part and a joined part of the arm part and the main body and the straight line connecting the contact part of the convex part and the wall part and the rotation center of the main body is represented as an angle B, the convex part or the concave part is formed such that 90 degrees>the angle A≥the angle B holds.

3. The sealing structure according to claim 2, wherein the convex part or the concave part is formed such that the angle A and the angle B are equal.

4. The sealing structure according to claim 1, wherein the concave part is formed in the predetermined member and the convex part is formed in the arm part.

5. The sealing structure according to claim 1, wherein the convex part is formed in the predetermined member and the concave part is formed in the arm part.

6. The sealing structure according to claim 1, wherein the predetermined member is made of resin.

7. The sealing structure according to claim 1, wherein
the predetermined member is an oil pan, and
the sealing member is a drain plug.
